(19) United States
(12) Patent Application Publication
(10) Pub. No.: US 2002/0062915 A1
(43) Pub. Date: May 30, 2002

(54) Method and apparatus for manufacturing a lens sheet

(76) Inventors: Kazuyuki Matsumoto, Tokyo-to (JP); Yoshinobu Sakemi, Tokyo-to (JP)

Correspondence Address: LADAS & PARRY, 224 SOUTH MICHIGAN AVENUE, SUITE 1200, CHICAGO, IL, 60604, US

(21) Appl. No.: 10/007,834

(22) Filed: Nov. 5, 2001

(30) Foreign Application Priority Data
Nov. 28, 2000 (JP) P2000-361188

(51) Int. Cl. B29C 47/00

(52) U.S. Cl. 156/245; 156/272.2; 156/379.6

(57) ABSTRACT

An apparatus for manufacturing a lens sheet comprises a nozzle, a substrate supply device, a pressing roller and an irradiation device. The nozzle applies applying ionizing radiation curing type resin in a form of liquid on the upper surface of a forming mold to form an uncured resin layer on the upper surface of the forming mold. The substrate supply device puts a substrate in an inclined state relative to the upper surface of the forming mold and placing the substrate on the uncured resin layer. The pressing roller presses the substrate against the uncured resin layer. The irradiation device irradiates ionizing radiation on the uncured resin layer through the substrate to cure the uncured resin layer.

### BACKGROUND OF THE INVENTION

1. Field of the Invention

The present invention relates a method and an apparatus for manufacturing lens sheets such as Fresnel lens sheets.

2. Description of the Related Art

Japanese Laid-Open Patent Application Nos. S64-86102, H6-67002 and H7-148751 disclose a method for manufacturing various kinds of lens sheet such as Fresnel lens sheets, lenticular lens sheets or the like, which are to be used for a transmission type screen for a projection TV.

According to the manufacturing method, which is disclosed in Japanese Laid-Open Patent Application No. S64-86102, a lens sheet is manufactured by carrying out the following steps. First, ultraviolet ray curing type resin in the form of liquid is applied on the entirety of the upper surface of a forming mold to form an uncured resin layer. Then, the ultraviolet ray curing type resin in the form of liquid is applied on one side of the uncured resin layer to form an uncured resin pool. Then, a sheet-shaped substrate is placed on the uncured resin pool. The uncured resin pool and the uncured resin layer are pressed together with the substrate against the forming mold by means of a pressing roller from the above-mentioned one side of the uncured resin layer toward the other side thereof so as to obtain a laminate structure of the substrate and the ultraviolet ray curing type resin, while excluding bubbles from the ultraviolet ray curing type resin. Then, ultraviolet ray is irradiated on the ultraviolet ray curing type resin through the substrate to cure it. Then, the cured resin is peeled together with the substrate from the forming mold, thus manufacturing a lens sheet.

According to the manufacturing method, which is disclosed in Japanese Laid-Open Patent Application No. H6-67002, a lens sheet is manufactured by carrying out the following steps. First, ultraviolet ray curing type resin in the form of liquid is applied on the entirety of the upper surface of a forming mold to form an uncured resin layer. Ultraviolet ray is irradiated on the uncured resin layer to cure it. The ultraviolet ray curing type resin is further applied on the cured resin layer. Then, the thus applied ultraviolet curing type resin is spread through a sheet-shaped substrate into a uncured resin layer by means of a pressing roller so as to obtain a laminate structure of the substrate, the cured resin layer and the uncured resin layer, while excluding bubbles from the ultraviolet ray curing type resin. Then, the ultraviolet ray is irradiated on the uncured resin layer through the substrate to cure it. Then, the cured resin is peeled together with the substrate from the forming mold, thus manufacturing a lens sheet.

According to the manufacturing method, which is disclosed in Japanese Laid-Open Patent Application No. H7-148751, a lens sheet is manufactured by carrying out the following steps. First, ultraviolet ray curing type resin in the form of liquid is applied on the entirety of the upper surface of a forming mold to form an uncured resin layer. Solvent contained in the ultraviolet ray curing type resin is vaporized by a hot-air dryer to form a solvent-vaporized layer. Then, the ultraviolet ray curing type resin is applied on one side of the solvent-vaporized layer to form an uncured resin pool. Then, the uncured resin pool is spread through a sheet-shaped substrate into a uncured resin layer by means of a pressing roller so as to obtain a laminate structure of the substrate, the solvent-vaporized layer and the uncured resin layer, while excluding bubbles from the ultraviolet ray curing type resin. Then, the ultraviolet ray is irradiated on the uncured resin layer through the substrate to cure it. Then, the cured resin is peeled together with the substrate from the forming mold, thus manufacturing a lens sheet.

However, the above-mentioned prior art has a problem that a relatively large amount of bubbles is entrapped in the ionizing radiation curing type resin such as the ultraviolet ray curing type resin, which is applied on the forming mold.

### SUMMARY OF THE INVENTION

An object of the present invention is therefore to provide a method and an apparatus for manufacturing a lens sheet, which permits to reduce an amount of bubbles, which are entrapped in ionizing radiation curing type resin applied on the forming mold, in comparison with the conventional method and apparatus.

Another object of the present invention is to provide a method and an apparatus for manufacturing a lens sheet, which permits to reduce effectively an amount of ionizing radiation curing type resin as used, in comparison with the conventional method and apparatus.

The conventional manufacturing method described in Japanese Laid-Open Patent Application No. H6-67002, in which entrapment of bubbles is prevented by placing the substrate on the ionizing radiation curing type resin as applied, while curving the substrate by means of a roller, has a problem of deformation and/or deterioration of the substrate. A further another object of the present invention is to provide a method and an apparatus for manufacturing a lens sheet, which permits to solve such a problem.

In order to attain the aforementioned object, the method of the first aspect of the present invention for manufacturing a lens sheet comprises:

a resin-application step for applying ionizing radiation curing type resin in a form of liquid on an entirety of an upper surface of a forming mold to form an uncured resin layer on the upper surface of said forming mold;

a laminating step for putting a substrate in an inclined state relative to the upper surface of said forming mold, then placing the substrate on said uncured resin layer and then pressing said substrate against said uncured resin layer by means of a pressing roller;

a curing step for irradiating ionizing radiation on said uncured resin layer through said substrate to cure said uncured resin layer, thereby forming a cured resin layer; and

a removing step for removing said cured resin layer together with said substrate from said forming mold.

According to the above-mentioned features of the first aspect of the present invention, the substrate is put in the inclined state relative to the upper surface of the forming mold, placed on the uncured resin layer and then pressed against the uncured resin layer by means of the pressing roller. It is therefore possible to flatten the resin so as not to entrap bubbles therein, without applying the ionizing radiation curing type resin in an increased thickness or forming an uncured resin pool on a part of the upper surface of the forming mold on a pressing-starting side. An amount of ionizing radiation curing type resin as used can be reduced. The substrate is placed on the uncured resin layer in the inclined state, without curving or bending the substrate, thus making it possible to prevent the substrate from being deformed and/or deteriorated.

In the second aspect of the present invention, the pressing of said laminating step may comprise continuously pressing said substrate from said one side of the forming mold to an other side thereof, said one side of the forming mold serving as a pressing-starting side; and there may be carried out, after said resin-application step and before said laminating step, a partial-surface application step for applying the ionizing radiation curing type resin on a part of said uncured resin layer on said pressing-starting side to form a uncured resin pool thereon. According to such a feature, if an amount of ionizing radiation curing type resin as first applied is insufficient, it is possible to supplement such an insufficient amount of resin. In addition, in cooperation with the feature that the substrate is put in the inclined state relative to the upper surface of the forming mold, placed on the uncured resin layer and then pressed against the uncured resin layer by means of the pressing roller, entrapment of bubbles can be prevented even when an amount of resin for the uncured resin pool is relatively small.

In the third aspect of the present invention, the method may further comprise a mold-temperature adjusting step for adjusting temperature of the forming mold to a prescribed temperature, which is suitable to formation of a lens sheet, said mold-temperature adjusting step being followed by said resin-application step. According to such a feature, the temperature of the forming mold is adjusted to the prescribed temperature, which is suitable to formation of the lens sheet. It is therefore possible to ensure a smooth flow of the ionizing radiation curing type resin as applied by the resin-application step when flattening it through the substrate by means of the pressing roller so as to prevent properly bubbles from being entrapped between the substrate and the forming mold.

In the fourth aspect of the present invention, said resin-application step, said laminating step, said curing step and said removing step may be carried out on a traveling passage of an endless conveying device for conveying the forming mold, and said mold-temperature adjusting step may be carried out on a returning passage of said endless conveying device. According to such a feature, it is possible to manufacture a lens sheet, while circulating the forming molds on the endless conveying device. In addition, the temperature of the forming mold can be adjusted before it is returned to the starting position of the traveling passage. Consequently, manufacture of a lens sheet can be conducted without specifically providing any period of time for carrying out a mold-temperature adjusting step.

In order to attain the aforementioned object, the apparatus of the fifth aspect of the present invention for manufacturing a lens sheet comprises:

a nozzle for applying ionizing radiation curing type resin in a form of liquid on an upper surface of a forming mold to form an uncured resin layer on the upper surface of said forming mold;

a substrate supply device for putting a substrate in an inclined state relative to the upper surface of said forming mold and placing the substrate on said uncured resin layer;

a pressing roller for pressing said substrate against said uncured resin layer; and

an irradiation device for irradiating ionizing radiation on said uncured resin layer through said substrate to cure said uncured resin layer.

According to the above-mentioned features of the fifth aspect of the present invention, the ionizing radiation curing type resin as applied by the nozzle is flattened through the substrate by means of the pressing roller so as to prevent properly bubbles from being entrapped between the substrate and the forming mold. In addition, in cooperation with the feature that the substrate is put in the inclined state relative to the upper surface of the forming mold, placed on the uncured resin layer and then pressed against the uncured resin layer by means of the pressing roller, it is possible to flatten the uncured resin layer so as not to entrap bubbles, without applying the ionizing radiation curing type resin on a pressing-starting side of the forming mold. An amount of ionizing radiation curing type resin as used can be reduced. The substrate is placed on the uncured resin layer in the inclined state, without curving or bending the substrate, thus making it possible to prevent the substrate from being deformed and/or deteriorated.

In the sixth aspect of the present invention, the apparatus may further comprise an additional nozzle for applying the ionizing radiation curing type resin on a part of said uncured resin layer to form a uncured resin pool thereon. According to such a feature, if an amount of ionizing radiation curing type resin as first applied is insufficient, it is possible to supplement such an insufficient amount of resin by means of the nozzle for applying the resin to form the uncured resin pool. In addition, in cooperation with the feature that the substrate is put in the inclined state relative to the upper surface of the forming mold, placed on the uncured resin layer and then pressed against the uncured resin layer by means of the pressing roller, it is possible to flatten the ionizing radiation curing type resin, without causing entrapment of bubbles, even when an amount of resin for the uncured resin pool is relatively small.

In the seventh aspect of the present invention, the apparatus may further comprise a mold-temperature adjusting device for adjusting temperature of the forming mold to a prescribed temperature, which is suitable to formation of a lens sheet. According to such a feature, the temperature of the forming mold is adjusted to the prescribed temperature, which is suitable to formation of the lens sheet. It is therefore possible to ensure a smooth flow of the ionizing radiation curing type resin as applied on the forming mold when flattening it through the substrate by means of the pressing roller so as to prevent properly bubbles from being entrapped between the substrate and the forming mold.

In the eighth aspect of the present invention, said nozzle, said substrate supply device, said pressing roller and said irradiation device may be provided on a traveling passage of an endless conveying device for conveying the forming mold, and said mold-temperature adjusting device may be provided on a returning passage of said endless conveying device. According to such a feature, it is possible to manufacture a lens sheet, while circulating the forming molds on the endless conveying device. In addition, the mold-temperature adjusting device is disposed on the returning passage of the endless conveying device so that the temperature of the forming mold can be adjusted before it is returned to the starting position of the traveling passage. Consequently, temperature adjustment of the forming mold can be carried out utilizing a non-service period of time for the forming mold. It is also possible to prevent the length of the conveying device from increasing.

In the ninth aspect of the present invention, said substrate supply device may supply the substrate in synchronization with traveling of the forming mold, which is caused by driving of the traveling passage of said endless conveying device. According to such a feature, it is possible to place the substrate on the ionizing radiation curing type resin, while traveling the forming mold, thus improving efficiency in manufacture of a lens sheet.

In the present invention, the “forming mold” means a device for forming or molding a lens sheet and includes a forming die.

### BRIEF DESCRIPTION OF THE DRAWINGS

FIGS. 1(A) to 1(G) are descriptive views illustrating steps in sequence of a lens sheet manufacturing method of the first embodiment of the present invention;

FIGS. 2(A) and 2(B) are plan views of a lens sheet manufactured by the lens sheet manufacturing method as shown in FIG. 1;

FIG. 3 is a perspective view illustrating a step for removing the lens sheet from a forming mold;

FIG. 4 is a plan view of the forming mold;

FIG. 5 is a cross-sectional view cut along the line V-V in FIG. 4;

FIG. 6 is an elevation view illustrating a lens sheet manufacturing apparatus;

FIG. 7 is a descriptive view of the lens sheet manufacturing apparatus, having a viewing direction based on the line VII-VII in FIG. 6;

FIG. 8 is a cross-sectional view cut along the line VIII-VIII in FIG. 7;

FIG. 9 is a view illustrating a piping system in a device for supplying ionizing radiation curing type resin;

FIG. 10 is a cross-sectional view illustrating a pump in the device for supplying the ionizing radiation curing type resin;

FIGS. 11(A) to 11(I) are descriptive views of operation of a substrate supply device;

FIG. 12 is a front view of a pressing roller;

FIG. 13 is a cross-sectional view cut along the line XIII-XIII in FIG. 12;

FIG. 14 is a view illustrating a piping system in a device for supplying ionizing radiation curing type resin in the second embodiment of the present invention; and

FIG. 15 is a view illustrating arrangements of nozzles in the second embodiment of the present invention.

### DETAILED DESCRIPTION OF THE PREFERRED EMBODIMENTS

Now, embodiments of the present invention will be described in detail below with reference to the accompanying drawings.

<First Embodiment>

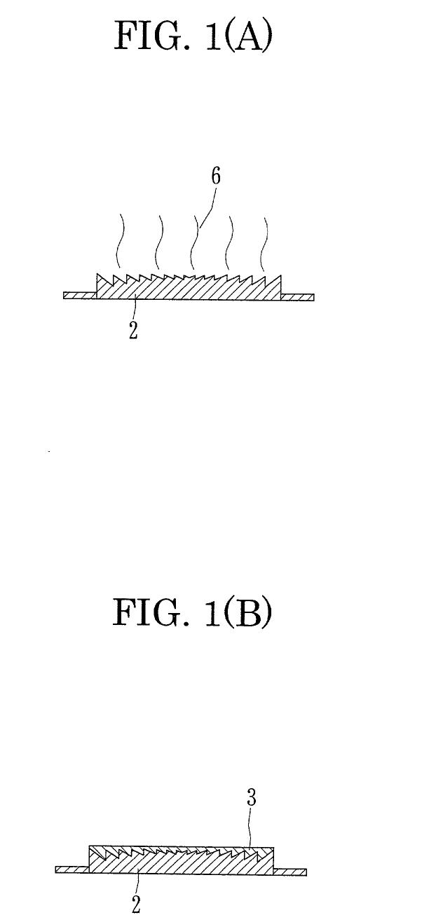

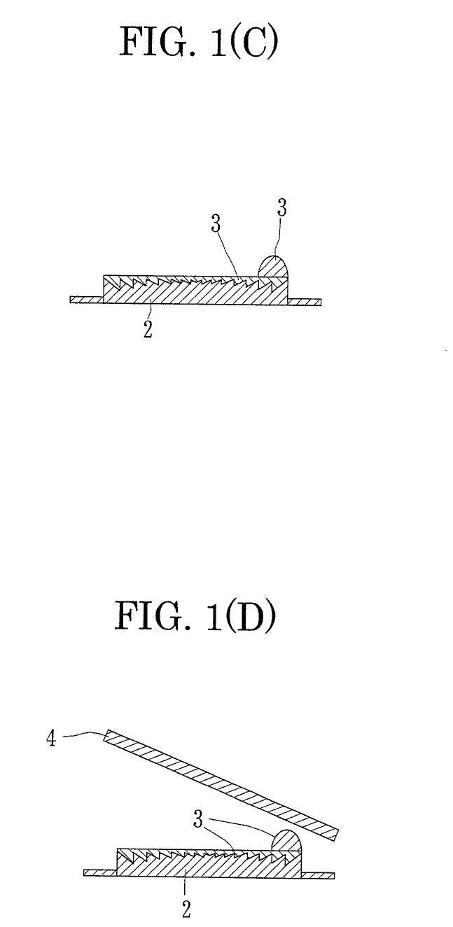

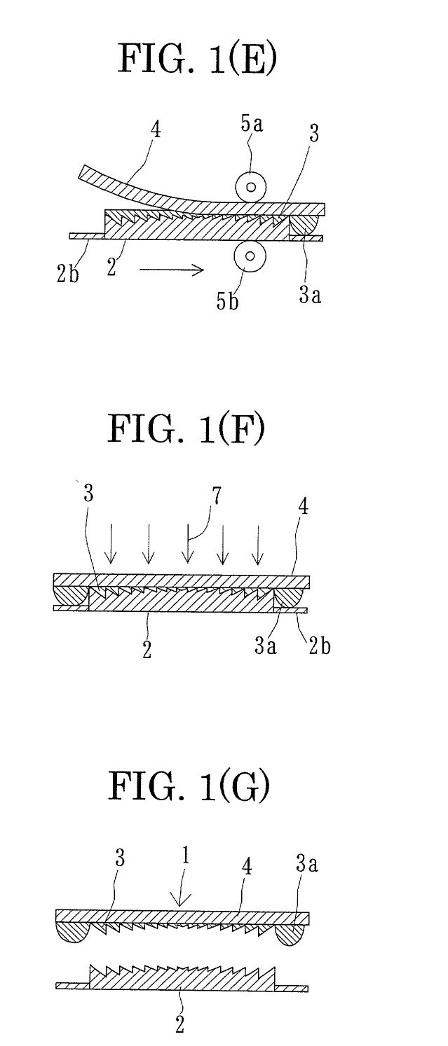

A lens sheet is manufactured in accordance with a manufacturing method as shown in FIG. 1. The lens sheet 1 is a Fresnel lens sheet. The method of the present invention may be applied not only to the manufacture of the Fresnel lens sheet, but also to the a manufacture of a lenticular lens sheet or the like.

As shown in FIGS. 1(A) to 1(G), the lens sheet 1 is manufactured by carrying out a temperature adjusting step (A) for make adjustment of temperature of a forming mold 2 for the lens sheet 1 to a prescribed temperature, which is suitable to formation of the lens sheet 1; the first resin-application step (i.e., the full-surface application step) (B) for applying ionizing radiation curing type resin 3 in the form of liquid on the entirety of the upper surface of the forming mold 2, to which the above-mentioned temperature adjusting step (A) has been applied, to form the first uncured resin layer; the second resin-application step (i.e., the partial-surface application step) (C) for applying the ionizing radiation curing type resin 3 in the form of liquid on one side, i.e., a pressing-starting side of the first uncured layer, which has been applied on the forming mold 2, to form an uncured resin pool; a substrate supplying step (D) for putting a substrate 4 in an inclined state relative to the upper surface of the forming mold 2 and then placing the substrate 4 on the first uncured resin layer and the uncured resin pool from above the forming mold 2; a laminating step (E) for pressing the substrate 4 and the forming mold 2 from the pressing-starting side toward the pressing-finishing side by means of a pair of pressing rollers 5a, 5b to spread the uncured resin pool over the first uncured resin layer and flatten it so that an superfluous amount of resin 3 reaches the periphery of a mold body of the forming mold 2, thereby forming the second uncured resin layer on the first uncured resin layer so as to provide a laminate structure of the first and second uncured resin layers and the substrate 4; a resin-curing step (F) for irradiating ionizing radiation onto the first and second uncured resin layers through the substrate 4 to cure them; and a removing step (G) for removing the ionizing radiation curing type resin 3 as cured from the forming mold 2 together with the substrate 4.

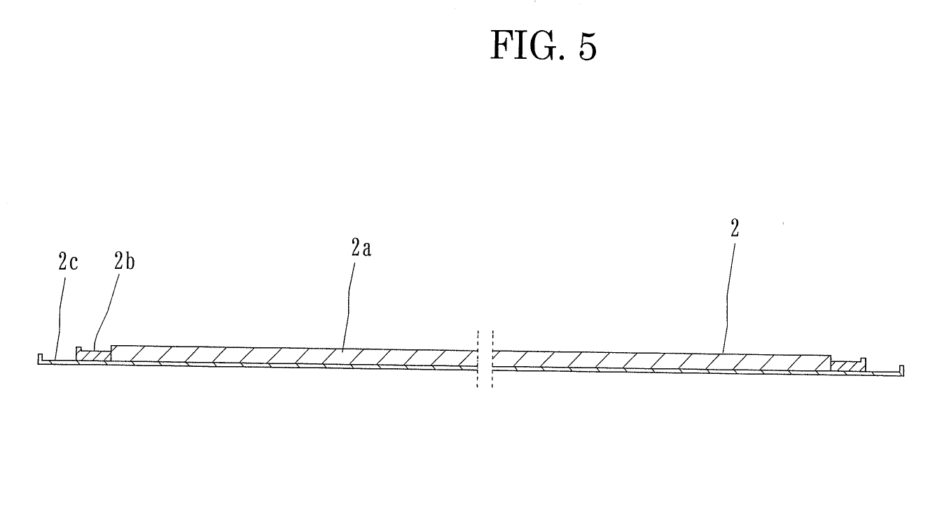

The forming mold 2 used in the method of the present invention has a mold body 2a, a receiving member 2b surrounding the periphery of the mold body 2a and a base plate 2c having a disc-shape so as to surround the receiving member 2b, as shown in FIGS. 4 and 5. A cutting mold, an electrocasting mold, a resin mold or the like may be used as the mold body 2a. The receiving member 2b and the base plate 2c may be omitted, as an occasion demands. The mold body 2a, which is a metallic mold formed by for example an electrocasting method, has on its upper surface a lens formation surface on which ionizing radiation curing type resin is to be applied. The receiving member 2b, which projects outside from the four peripheral sides of the mold body 2a, receives the superfluous amount of ionizing radiation curing type resin 3a overflowed from the mold body 2. The base plate 2c supports the mold body 2a and the receiving member from below thereof.

The temperature-adjusting step (A) is to heat uniformly the forming mold 2 to a temperature, which is suitable to formation of the lens sheet. The step (A) is carried out for example by blowing hot air 6 heated by an electric heater, dried vapor or the like on the forming mold 2 in a prescribed period of time. The blowing step of the hot air 6 may be applied uniformly to the entirety of the forming mold 2, or in a manner that a flow rate of the hot air 6 is increased for a local portion, which is apt to be cooled. The flow rate of the hot air 6 can be adjusted by changing opening areas of a plurality of nozzles, while blowing the hot air 6 from these nozzles, or regulating an opening of a damper, which is provided on the upstream side of the nozzle. The temperature adjustment of the forming mold 2 can also be made with the use of a temperature adjustment device disposed on the forming mold 2.

In case where the ionizing radiation curing type resin 3 applied in accordance with the first resin-application step (B) and the second resin-application step (C) contains solvent, the above-described temperature-adjusting step (A) has functions not only of heating the forming mold 2, but also of removing the solvent. Removal of the solvent from the ionizing radiation curing type resin 3 prevents bubbles from being entrapped in the lens. The forming mold 2 may be heated excessively by ionizing radiation 7, which is irradiated in accordance with the resin-curing step (F). In such a case, the temperature adjusting step (A) makes it possible to cool the forming mold 7 excessively heated to an optimum temperature.

The first resin-application step (i.e., the full-surface application step) (B) is to apply the ionizing radiation curing type resin 3 in the form of liquid on the entirety of the upper surface of the forming mold 2, to which the temperature-adjusting step (A) has been applied, to form the first uncured layer. In such a step (B), the ionizing radiation curing type resin 3 is poured in the form of liquid on the forming mold 2 for example through a single nozzle or a plurality of nozzles. Application of the ionizing radiation curing type resin 3 in the form of liquid is conducted, while one or both of the forming mold 2 and the nozzle is traveled. It is preferable to apply the ionizing radiation curing type liquid resin 3 on the forming mold 2 from one side thereof to the other side thereof, while pouring the resin 3 in the form of threads from a plurality of nozzles each having a small discharging opening. This makes it possible to prevent air from being entrapped into lens formation grooves on a lens formation surface of the forming mold 2. The forming mold 2 has also been subjected to the temperature adjustment step to be heated uniformly. Accordingly, the ionizing radiation curing type liquid resin as applied rapidly extends over the lens formation grooves without entrapping bubbles.

Ultraviolet ray curing type resin, electron beam curing type resin or the like may be used as the ionizing radiation curing type liquid resin 3.

The second resin-application step (i.e., the partial-surface application step) (C) is to apply the ionizing radiation curing type liquid resin 3 on one side, i.e., the pressing-starting side of the first uncured layer, which has been applied on the forming mold 2, to from an uncured resin pool on the pressing-starting side. The ionizing radiation curing type liquid resin is poured on the forming mold 2 through the same single nozzle or plurality of nozzles as in the first resin-application step (B) or an ordinary single nozzle to form the uncured resin pool. The second resin-application step (C) may be omitted as an occasion demands.

The substrate supplying step (D) is to put a substrate 4 in an inclined state relative to the upper surface of the forming mold 2 and then place a substrate 4 on the first uncured resin layer and the uncured resin pool of the ionizing radiation curing type resin 3 from above the forming mold 2. For example, a plurality of suction cups disposed on an inclined plane suck the substrate 4 having a sheet-shape and are moved to carry the substrate 4 obliquely downward on the forming mold 2 on which the first uncured resin layer and the uncured resin pool of the ionizing radiation curing type resin 3 have been formed. The substrate 4 may be carried with the use of a guide plate, belt or roller, which is disposed obliquely. The substrate 4 first comes, at its front edge that is directed obliquely downward, into contact with the uncured resin pool 3 of the ionizing radiation curing type resin, which is placed on the pressing-starting side of the forming mold 2.

The substrate 4 is formed of a transparent thin sheet such as an acrylic resin sheet through which ionizing radiation such as ultraviolet ray or electron beam permeates.

The laminating step (E) is to put the substrate 4 in an inclined state relative to the upper surface of the forming mold 2 and then press the substrate 4 against the first uncured resin layer and the uncured resin pool of the ionizing radiation curing type resin 3 on the forming mold 2 from the pressing-starting side toward the pressing-finishing side. More specifically, the substrate 4 gradually comes, from its lower end to its upper end, into contact with the ionizing radiation curing type resin 3 so that the portion of the substrate 4, which is placed behind a pair of pressing rollers 5a, 5b in the pressing direction, is kept in the inclined state. The forming mold 2 on which the first uncured resin layer and the uncured resin pool of the ionizing radiation curing type resin 3 have been formed and then the front end of the substrate 4 has been placed thereon, is passed between the pressing rollers 5a, 5b to spread the uncured resin pool over the first uncured resin layer, so as to form the second uncured resin layer on the first uncured resin layer. As a result, the first uncured resin layer and the second uncured resin layer are combined into a united layer. The uncured resin pool of the ionizing radiation curing type resin 3 applied in accordance with the second resin-application step (C) is spread over the first uncured resin layer from the pressing-starting side toward the pressing-finishing side so as to press bubbles out of the ionizing radiation curing type resin 3, thus preventing bubbles from being entrapped between the substrate 4 and the forming mold 2. After the forming mold 2 on which the ionizing radiation curing type resin 3 has been applied is passed together with the substrate between the pressing rollers 5a, 5b, the united layer of the first and second uncured resin layers is flatten in a uniform thickness. Of the pair of pressing rollers 5a, 5b, the upper roller 5a, which comes into contact with the substrate 4, is preferably provided with a crown. Such a crown causes the ionizing radiation curing type resin 3 to flow smoothly into the lens formation grooves, which are formed concentrically, without entrapping bubbles in these grooves. In addition, the forming mold 2 is previously subjected to the temperature adjustment in the laminating step (E). As a result, the ionizing radiation curing type resin 3 flows smoothly on the forming mold 2, which is heated to an appropriate temperature, and comes securely in close contact with the substrate 4.

The resin-curing step (F) is to irradiate ionizing radiation onto the first and second uncured resin layers through the substrate 4 to cure them. More specifically, a radiation source such as an ultraviolet ray lamp is disposed above the forming mold 2 to irradiate uniformly ionizing radiation 7 on the substrate 4. The ionizing radiation 7, which permeates through the substrate 4, acts on the ionizing radiation curing type resin 3 applied on the forming mold to cure it. The ionizing radiation curing type resin 3 as cured adheres firmly to the substrate 4.

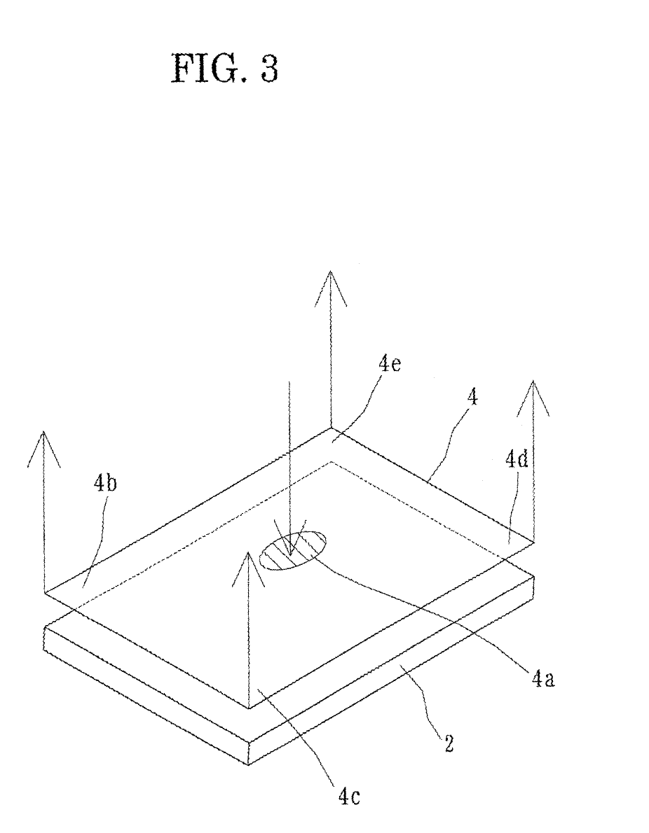

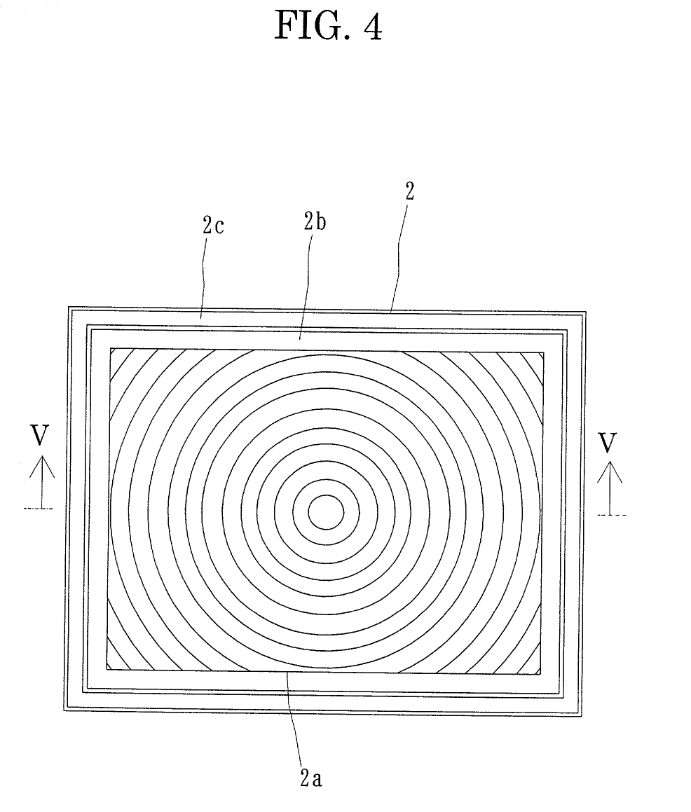

The removing step (G) is to removing the ionizing radiation curing type resin 3 as cured thorough irradiation of the ionizing radiation 7 from the forming mold 2 together with the substrate 4. More specifically, manual operations will be carried out as follows. First, the central portion of the substrate 4 is urged against the forming mold 2 and the opposite portions 4b, 4d placed along a diagonal line of the lens sheet 1 are caught and lifted up as shown in FIG. 3. Accordingly, the ionizing radiation curing type resin 3 is peeled from the forming mold 2 from the vicinities to the opposite portions 4b, 4d toward the central portion. Then, the opposite portions 4b, 4d placed along the diagonal line of the substrate 4 are moved down on the forming mold 2. The other opposite portions 4c, 4e placed along the other diagonal line of the substrate 4 are caught and lifted up. Accordingly, the ionizing radiation curing type resin 3 is peeled from the forming mold 2 from the vicinities to the other opposite portions 4c, 4e toward the central portion. Finally, all the two pairs of opposite portions 4b, 4c, 4d, 4e are caught and lifted up simultaneously so that the whole ionizing radiation curing type resin 3 is completely peeled from the forming mold 2.

The removing step may be carried out as follows. First, a pair of opposite sides of the substrate 4 is simultaneously lifted up and the other pair of opposite sides of the substrate 4 is also simultaneously lifted up. Such a lifting-up operation is repeated several times to peel gradually the ionizing radiation curing type resin 3 from the periphery of the lens sheet toward the central portion thereof. Finally, the whole lens sheet 1 is lifted up above the forming mold 2, while pushing the central portion 4a of the substrate 4 toward the forming mold 2. The whole ionizing radiation curing type resin 3 is completely peeled from the forming mold 2 together with the substrate 4.

Sharp irregularities exist on the bottom of the lens formation grooves or between the adjacent lens formation grooves on the Fresnel lens formation surface of the forming mold 2, as shown in FIGS. 1(A) to 1(G). Operations of catching one side or corner of the substrate and peeling it toward the other side or corner may damage the irregularities of the Fresnel lens formed of the ionizing radiation curing type resin 3, thus degrading performance of the lens. The above-described removing step however makes it possible to prevent the irregularities of the Fresnel lens formed of the ionizing radiation curing type resin 3 from being damaged by the forming mold 2.

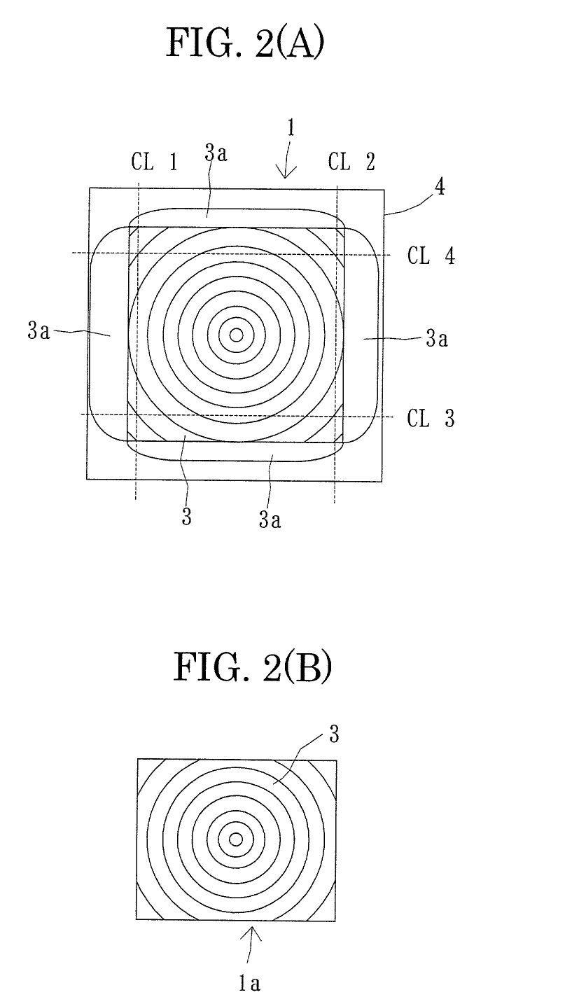

The Fresnel lens sheet 1 can be prepared by carrying out all of the steps (A) to (G). The substrate 4 of the Fresnel lens sheet 1 has a superfluous amount of ionizing radiation curing type resin 3, which has extended from the four sides of the forming mold 2 to adhere on the substrate 4 and been cured, as shown in FIG. 2(A). Cutting operations of useless end portions having a superfluous amount of ionizing radiation curing type resin 3 are applied, as an occasion demands, to the Fresnel lens sheet 1 along cutting lines CL1, CL2, CL3 and CL4 as shown in FIG. 2(A) to remove the useless end portions, thus obtaining the Fresnel lens sheet la as the finished product.

In the above-described method for manufacturing the lens sheet, there may be adopted a structure in which (i) the forming molds 2 are conveyed on an endless conveying device, (ii) the resin-application step, the laminating step, the curing step and the removing step are carried out on a traveling passage of the endless conveying device and (iii) the mold-temperature adjusting step is carried out on a returning passage of the endless conveying device. Such an arrangement of the devices for carrying out these steps makes it possible to effectively manufacture the lens sheet 1, while circulating the forming molds 2 on the endless conveying device. In addition, the temperature of the forming mold 2 can be adjusted before it is returned to the starting position of the traveling passage. Consequently, manufacture of the lens sheet 1 can be conducted without specifically providing any period of time for carrying out the mold-temperature adjusting step.

Now, description will be given below of a manufacturing apparatus, which is applied to carry out the method for manufacturing the above-mentioned lens sheet.

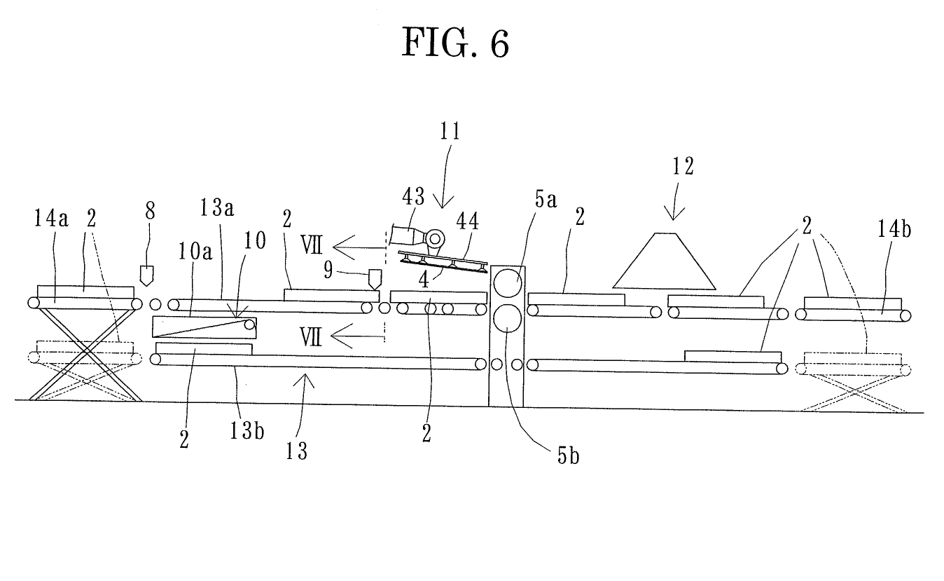

The apparatus for manufacturing a lens sheet includes, as shown in FIG. 6, a mold-temperature adjusting device 10, the first nozzle 8 serving as the first application device, the second nozzle 9 serving as the second application device, a substrate supply device 11, the pair of pressing rollers 5a, 5b and an ionizing radiation irradiating device 12. The temperature-adjusting device 10 adjusts temperature of the forming mold 2 for the lens sheet 1 to a suitable temperature for formation of the lens sheet. The first nozzle 8 is used to apply the ionizing radiation curing type resin in the form of liquid on the entirety of the upper surface of the forming mold 2, the temperature of which has already been adjusted, to form the first uncured resin layer thereon. The second nozzle 9 is used to apply the ionizing radiation curing type resin in the form of liquid on a pressing-starting side of the first uncured layer to form an uncured resin pool. The substrate supply device 11 puts the substrate 4, through which ionizing radiation 7 permeates, in the inclined state relative to the upper surface of the forming mold 2 and places the substrate 4 on the first uncured resin layer and the uncured resin pool from above the forming mold 2. The pair of pressing rollers 5a, 5b presses the substrate 4, which is supplied by means of the substrate supply device 11, and the forming mold 2 from the pressing-starting side toward the pressing-finishing side to spread the uncured resin pool over the first uncured resin layer, thereby forming the second uncured resin layer on the first uncured resin layer. The ionizing radiation irradiating device 12 irradiates ionizing radiation 7 onto the first and second uncured resin layers of the ionizing radiation curing type resin 3 through the substrate 4 to cure them.

The apparatus for manufacturing a lens sheet has a conveying device 13 by which a plurality of forming molds 2 can be circulated therein. The conveying device 13 is provided on its upper side with a traveling passage 13a for the forming molds 2 and on its lower side with a returning passage 13b for them. The traveling passage 13a and the returning passage 13b are composed of a roller conveyer, a chain conveyer or the like. The conveying device 13 is provided on its opposite ends with lifters 14a, 14b. One lifter 14a has a function of moving the forming mold 2, which has been returned on the returning passage 13b, upward to the traveling passage 13a. The other lifter 14b has a function of moving the forming mold 2, which has been conveyed on the traveling passage 13a, downward to the returning passage 13b. The first and second nozzles 8, 9, the substrate supply device 11, the pressing rollers 5a, 5b and the ionizing radiation irradiating device 12 are disposed along the traveling passage 13a of the conveying device 13. The temperature-adjusting device 10 is disposed along the returning passage 13b of the conveying device 13. Each of the traveling passage 13a and the returning passage 13b of the conveying device 13 is divided into a plurality of endless conveying units, which can independently be driven at the respective independent speed or stopped in accordance with the steps carried out by the first and second nozzles 8, 9, the substrate supply device 11, the pressing rollers 5a, 5b and the ionizing radiation irradiating device 12.

Dies having the structure as shown in FIGS. 4 and 5 are prepared as the forming mold 2. These molds are disposed in a line on the conveying device 13.

The temperature-adjusting device 10 is provided on the returning passage 13b, and preferably in a connection position of the returning passage 13b with the lifter 14a for lifting the forming mold 2. The temperature-adjusting device 10, which is provided on the returning passage 13b, provides a system in which temperature of the forming mold 2 has been properly adjusted before the forming mold 2 enters the inlet of the traveling passage 13a. This makes it possible to make a temperature adjustment of the forming mold 2 during its non-service period of time, i.e., when the forming mold 2 does not contribute to the formation of the lens sheet, thus preventing the length of the conveying device 13 for the forming molds 2 from being lengthen unnecessarily. The temperature-adjusting device 10 has a chamber 10a for surrounding the forming mold 2, which stops once returning on the returning passage 13b. Dried vapor, hot air 6 heated by an electric heater or the like is supplied into the chamber 10a. The hot air 6, which is blown from the bottom of the chamber onto the forming mold 2 heats it to a suitable temperature for formation of the lens sheet. The forming mold 2 is kept in a stand-by state on the returning passage 13b until it is received by the lifter 14a for lifting the forming mold 2. The forming mold 2 is heated to a suitable temperature during such a stand-by state.

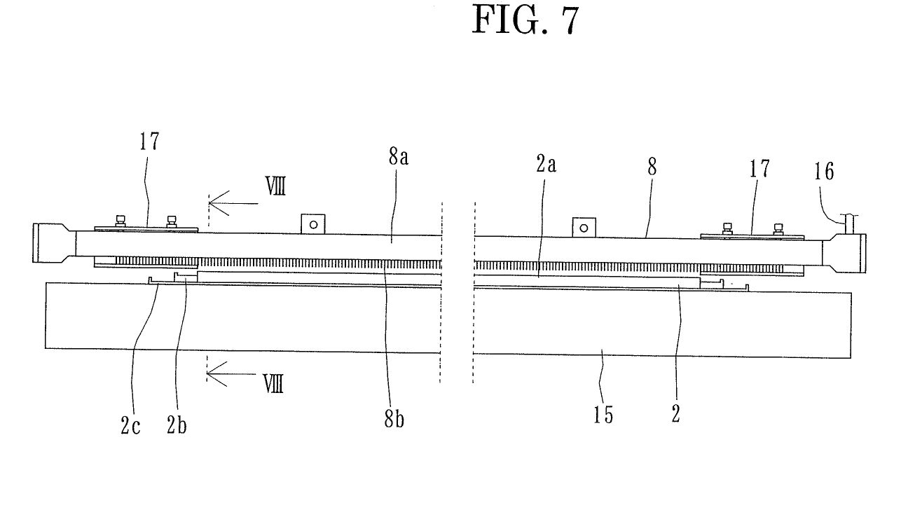

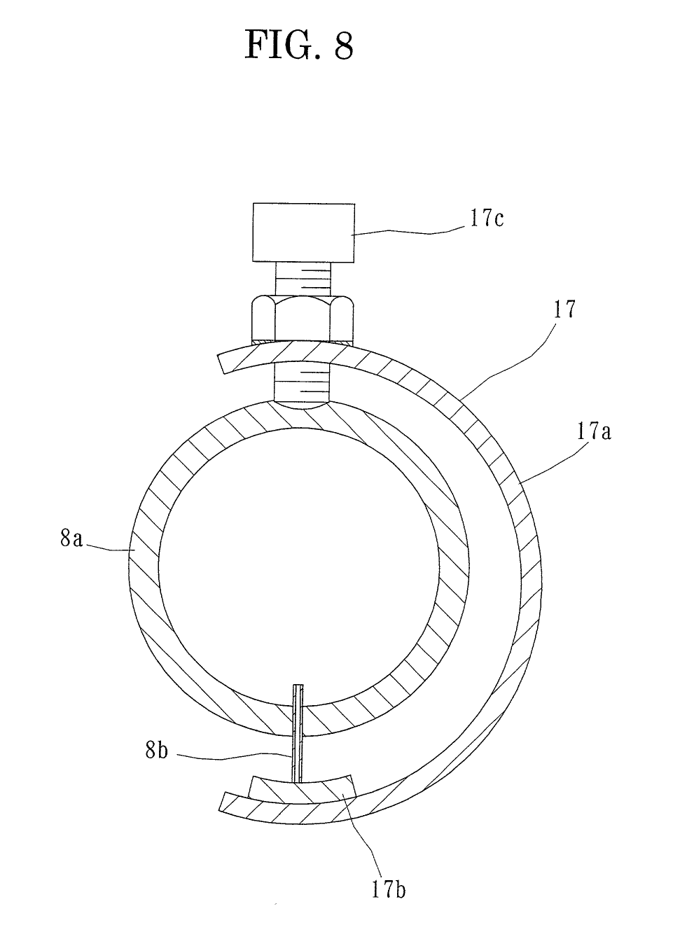

The first nozzle 8 is disposed on the inlet of the traveling passage 13a of the conveying device 13. More specifically, there is used as the first nozzle 8 a multiple nozzle, which has a structure as shown in FIGS. 7 and 8. The reference numeral “15” in FIG. 7 denotes the conveyer roller of the traveling passage 13. The multiple nozzle 8 is provided with a main pipe 8a, which is disposed horizontally in the transverse direction of the traveling passage 13a, and with a plurality of nozzle pipes 8b, which are disposed at regular intervals on a single line on the lower surface of the main pipe 8a. The main pipe 8a has the opposite closed ends. A supply conduit 19 for supplying the ionizing radiation curing type liquid resin is connected to a prescribed portion of the main pipe 8a. The nozzle pipes are formed of an elongated small-diameter pipe made of stainless steel and pass through the wall of the main pipe 8a and are secured thereto by means of press fitting. The ionizing radiation curing type liquid resin 3 supplied into the main pipe 8a is poured simultaneously from the tip ends of the nozzle pipes 8b, which are disposed in a line, and applied onto the forming mold 2, which travels below the nozzle pipes 8b or stops traveling.

There are normally prepared the plurality of forming molds 2 having the different dimensions in accordance with the size of the lens sheet 1 to be manufactured. There may however be prepared the first nozzle 8, which is used exclusively for the specific dimensions of the forming molds 2. Alternatively, a pair of adjusting devices 17 as shown in FIGS. 7 and 8 may be provided on the opposite sides of the main pine 8a so as to adjust an application width of the ionizing radiation curing type resin 3 in accordance with the width of the forming mold 2. Each of the adjusting devices 17 includes a supporting plate 17a, which curves so as to partially surround the main pipe 8a, a closing plate 17b made of flexible material such as rubber, which is secured on the inner surface of the supporting plate 17a, and a set screw 17c for holding stationarily the supporting plate 17a on the main pipe 8a. The supporting plate 17a is fitted on the main pipe 8a so that the closing plate 17b comes into contact with the tip ends of the nozzle pipes 8b. In such a state, the setscrew 17c is tighten so that the tip end of the setscrew 17c is urged against the outer surface of the main pipe 8a. The supporting plate 17a is stationarily secured on the main pipe 8a so that the tip ends of the nozzle pipes 8b, which are located outside the forming mold 2, are closed by the closing plate 17b, thereby adjusting an application width of the ionizing radiation cured type resin 3. Change in securing position of the adjusting device 17 on the main pipe 8a in an appropriate manner makes it possible to change the number of the nozzle pipes 8b, which are to be closed. However, there may previously be prepared the plurality of adjusting devices 17 having the different lengths to each other. In this case, selection of an appropriate one of these adjusting devices 17 makes it possible to change the number of the nozzle pipes 8b, which are to be closed, thereby adjusting an application width of the ionizing radiation cured type resin 3.

A single nozzle may be used in place of the multiple nozzle serving as the first nozzle 8. The single nozzle may be moved in a perpendicular direction to the traveling direction of the forming mold 2 so that the ionizing radiation curing type resin is applied onto the forming mold 2.

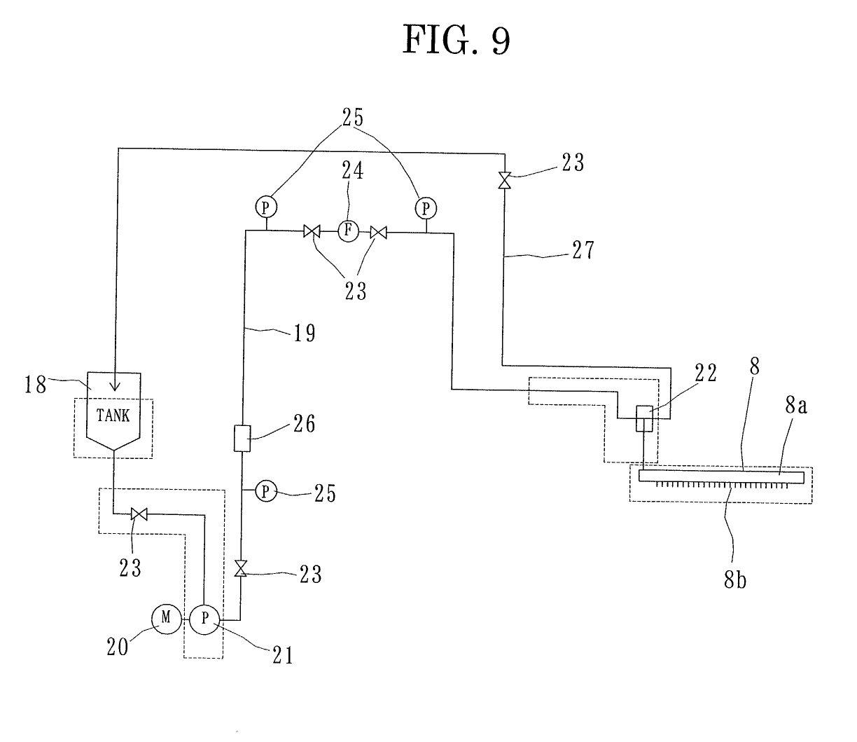

Supply of the ionizing radiation curing type liquid resin 3 into the first nozzle 8 is conducted by a resin supply device as shown in FIG. 9. In FIG. 9, a reference numeral “18 ” denotes a reservoir tank 18 for the ionizing radiation curing type liquid resin 3. A supply conduit 19 for the ionizing radiation curing type liquid resin 3 extends from the reservoir tank 18 to the first nozzle 8. The supply conduit 19 is provided with a pump 21 driven by a gear motor 20, a discharge valve 22 serving as a three way valve for permitting connection of the source of the ionizing radiation curing type resin 3 with the first nozzle 8 to supply the resin 3 into the first nozzle or disconnection thereof, a manual valve 23, a filter 24, a pressure gauge 25, a flow meter 26 and the like. Driving of the pump 21 causes the ionizing radiation curing type resin 3 received in the reservoir tank 18 to flow in the supply conduit 19 toward the discharge valve 22. When the forming mold 2 is moved in a prescribed position, the discharge valve 22 is opened so that the ionizing radiation curing type resin 3 flows into the main pipe 8a of the first nozzle 8. As a result, the ionizing radiation curing type resin 3 is poured onto the forming mold 2. The resin supply device is provided with a circulation device. A return conduit 27 extends from the discharge valve 22 to the reservoir tank 18. In a state where the resin is not poured, the discharge valve 22 closes the supply conduit 19 communicating with the first nozzle 8 and simultaneously connects the supply conduit 19 to the return conduit 27. Accordingly, the ionizing radiation curing type resin flowing in the supply conduit 19 passes through the return conduit 27 and returns into the reservoir tank 18, thus performing circulation between the supply conduit 19 and the return conduit 27.

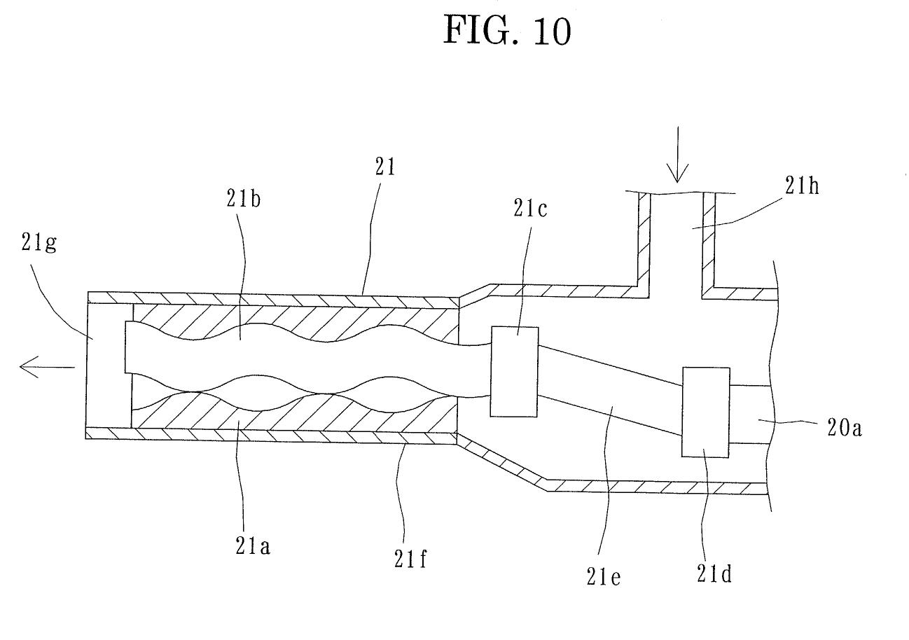

A displacement type-single eccentric shaft screw pump as shown in FIG. 10, which is so called “snake pump”, is used as the above-mentioned pump 21. The snake pump includes a stator 21a, which is made of resilient material and has a central through-hole with a elliptic cross section, a spiral-shaped rotor 21b inserted into the stator 21a, two universal joints 21c, 21d provided between the rotor 21b and an output shaft 20a of a gear motor 20, and a coupling rod 21e. A housing 21f of the pump 21 is provided at its portion in which the stator 21a is received, with a discharge port 21g connected with the supply conduit 19. The housing 21f is provided at its portion in which the universal joints and the other structural components are received, with a suction port 21h. The ionizing radiation curing type resin 3 received in the reservoir tank 18 is sucked from the suction port 21h into the stator 21a and supplied from the discharge port 2lg to the discharge valve 22. Pulsation does not easily occur in such a snake pump. Accordingly, the ionizing radiation curing type resin 3 can be discharged at a constant flow rate from the nozzle pipes 8b. The ionizing radiation curing type resin 3 can be applied on the forming mold 2 to form the layer having a uniform thickness. The snake pump imparts almost no shearing force to the ionizing radiation curing type resin 3, thus permitting to apply the resin onto the forming mold 2 without deterioration of the resin.

The ionizing radiation curing type liquid resin 3, temperature of which has already been adjusted, is applied on the entirety of the upper surface of the forming mold 2 by the first nozzle 8.

The second nozzle 9 is provided on the downstream side of the first nozzle 8 on the traveling passage of the conveying device 13. The second nozzle 9 may have the same structure as the first nozzle 8. Supply of the ionizing radiation curing type resin to the second nozzle 9 may be performed by causing the conduit of the piping for the ionizing radiation curing type resin supplied to the first nozzle 8 to branch off.

The ionizing radiation curing type liquid resin is applied on the pressing-starting side of the first uncured layer, which has been applied on the forming mold 2, to form an uncured resin pool.

The second nozzle 9 may be omitted, as an occasion demands. In such a case, there may be adopted an application system in which the ionizing radiation curing type resin 3 is applied onto the forming mold 2 by the first nozzle 8 to form the first uncured layer, and then the forming mold 2 is moved backward, and finally the ionizing radiation curing type resin 3 is applied on the one side of the first uncured layer to form an uncured resin pool.

Portions of the supply device for the ionizing radiation curing type resin, which are defined by dotted lines in FIG. 9, are heated by heaters in the shape of ribbon. More specifically, heating the reservoir tank 18, the pump 21, the discharge valve 22 and the nozzle 8 in an appropriate manner cases the ionizing radiation curing type resin to be poured smoothly from the first and second nozzles 8, 9. In addition, subjecting the ionizing radiation curing type resin 3 and the forming mold 2 to the respective temperature adjustments makes it possible to enhance formability of the ionizing radiation curing type resin 3.

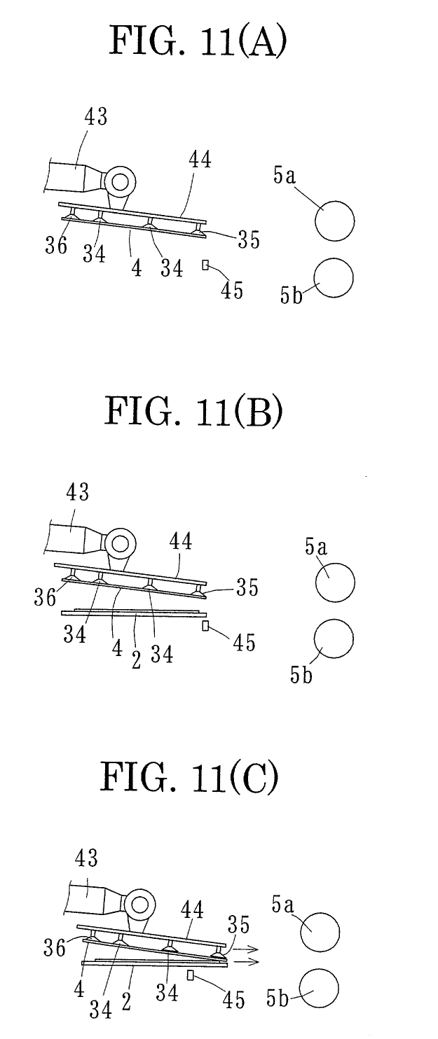

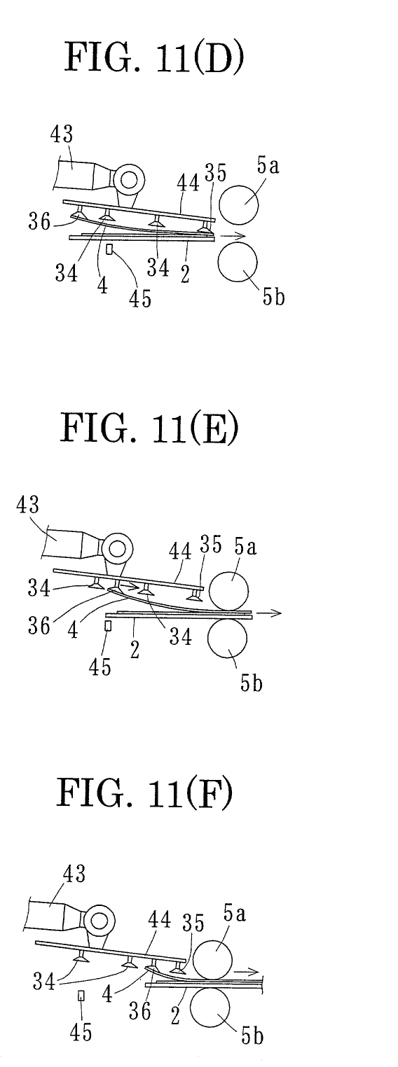

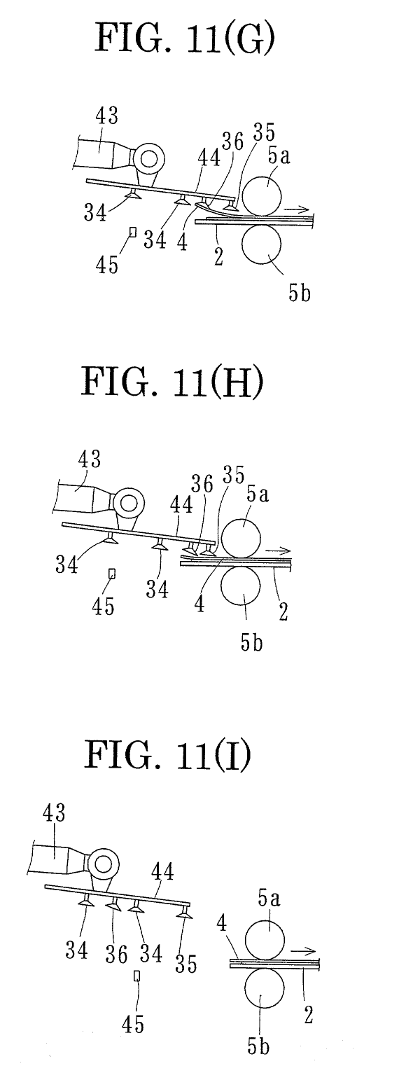

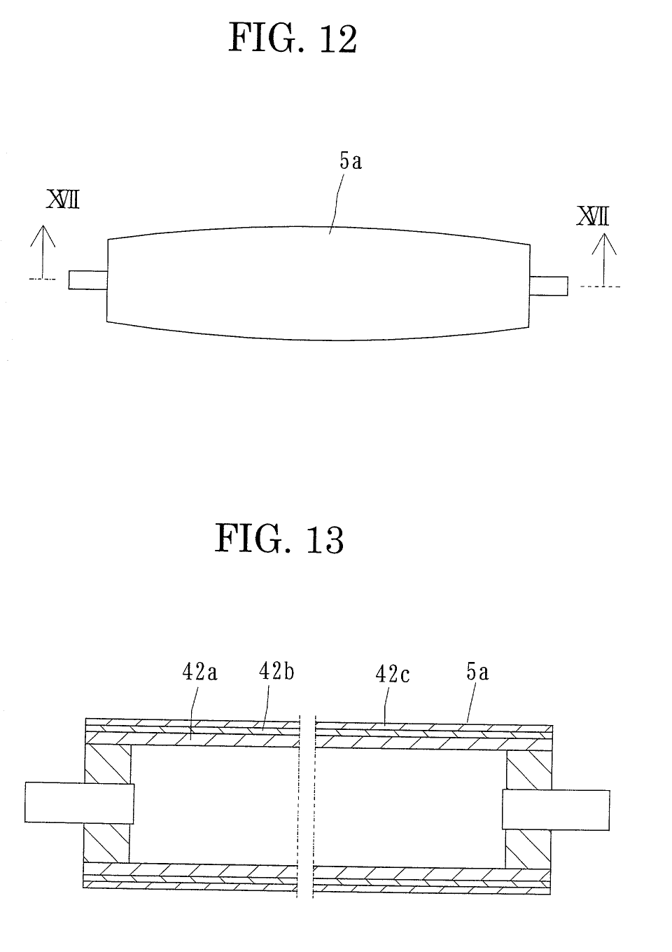

The substrate supply device 11 is provided on the downstream side of the second nozzle 9 on the traveling passage 13a of the conveying device 13. More specifically, the substrate supply device 11 is formed by a robot 43 as shown in FIGS. 11(A) to 11(I). The robot 43 may be for example a sequence robot controlled by a sequential control. A programmable controller or the like may be used as the sequential control device. The robot 43 has a plate-shaped hand 44, which is inclined so that the front edge of the hand 44 is lower than the rear edge thereof in the traveling direction of the forming mold 2. The hand 44 is provided on its lower surface with a plurality of suction cups 34, 35, 36, which are directed downward so as to permit to suck the substrate 4, which is kept in a state that the front edge of the substrate 4 is lower than the rear edge thereof in the traveling direction of the forming mold 2. The suction cup 36 is mounted on the lower surface of the hand 44 so as to be slidable in the traveling direction of the forming mold 2. The suction cup 36 is resiliently held in a prescribed position on the lower surface of the hand 44 by means of a spring (not shown). As a result, when the substrate 4 sucked by the suction cup 36 is pulled by the pressing rollers 5a, 5b, the suction cup 36 slides on the lower surface of the hand 44 toward the pressing rollers 5a, 5b against tensile forces of the spring as shown in FIG. 11(E).

Supplying operation of the substrate will be described below with reference to FIGS. 11(A) to 11(I). First, the suction cups 34, 35, 36 suck the substrate 4 and the hand 44 of the robot 43 is inclined and moved to a position above the traveling passage 13a of the endless conveying device 13 (see FIG. 11(A)). When a sensor 45, which is disposed below the traveling passage 13a, detects the presence of the front end of the forming mold 2, which has the ionizing radiation curing type resin 3 as applied thereon and travels on the traveling passage 13a (see FIG. 11(B)), the hand 44 presses the front end of the substrate 4 onto the front end of the forming mold 2 in synchronization with the travel of the forming mold 2 (see FIG. 11(C)). The hand 44 stops moving near the pressing rollers 5a, 5b and releases the suction of the substrate 4 by the suction cups 34 other than the suction cups 35, 36. Then, suction by the suction cup 35 is also released (see FIG. 11(D)). The substrate 4 is pulled by the pressing rollers 5a, 5b to be held therebetween and the suction cup 36 simultaneously moves forward on the hand 44 (see FIGS. 11(E), 11(F) and 11(G)). The movement of the suction cup 36 is caused by pulling forward the substrate 4, the surface of which the suction cup 36 sucks, by means of the pressing rollers 5a, 5b against tensile force of the spring (not shown), which resiliently connects the suction cup 36 to the hand 44. Alternatively, the suction cup 36 may be slidable by means of the other resilient device such as an air cylinder so as to be movable in synchronization with the pulling movement of the forming mold 2 and the substrate 4 by the pressing rollers 5a, 5b. The suction cup 36 may be slidable in synchronization manner by means of an NC control. As a result, the substrate 4 gradually comes, from its lower end to its upper end, into contact with the ionizing radiation curing type resin 3 as applied on the forming mold 2, while maintaining the inclined state, thus preventing bubbles from being entrapped into the ionizing radiation curing type resin 3. Then, the suction of the suction cup 36 of the hand 44 is released to disengage the substrate 4 (see FIG. 11(H)) and returns to its original position (see FIG. 11(I)). The hand 44 of the robot 43 also returns to its original position.

The pressing rollers 5a, 5b press the substrate 4, which is obliquely supplied by means of the hand 44 of the robot 43, against the ionizing radiation curing type resin 3 as applied on the forming mold 2, from the front side toward the rear side of the substrate 4 to form a laminate structure. The substrate 4 is obliquely supplied so that the rear end of the substrate 4 is higher than the front end thereof in this manner. Accordingly, it is possible to effectively prevent bubbles from being entrapped into the ionizing radiation curing type resin 3, even when the resin 3 is applied in a small thickness or an amount of the uncured resin pool is small. The total amount of ionizing radiation curing type resin 3 to be applied can therefore be reduced. With a large amount of ionizing radiation curing type resin 3 to be applied, the rear end of the substrate may float or sink in the resin layer 3, thus increasing rate of occurrence of entrapment of bubbles. Supplying obliquely the substrate 4 to the pressing rollers 5a, 5b so that the rear end of the substrate 4 is higher than the front end thereof, makes it possible to prevent improper oscillation movement of the substrate and perform an appropriate operation for removing bubbles.

The pressing rollers 5a, 5b are disposed on the downstream side of the substrate supply device 11 on the traveling passage 13a of the conveying device 13. The pressing rollers 5a, 5b are disposed so that the traveling passage 13a is placed between the pressing rollers 5a, 5b in the vertical direction. The lower roller 5b, which comes into contact with the lower surface of the forming mold 2, is formed of metal into a cylindrical shape. The upper roller 5a, which comes into contact with the substrate 4, which has been placed on the forming mold 2, is provided with a crown, as shown in FIG. 16. The upper roller 5a has a three-layer structure as shown in FIG. 17, which is composed of an innermost layer 42a formed of a cylindrical metallic pipe, an intermediate layer 42b made of rubber and an outermost layer 42c made of sponge. The outermost layer 42c made of sponge forms the above-mentioned crown. The intermediate layer made of rubber may be omitted. The upper roller 5a is moved up and down by means of an air cylinder (not shown). A plurality of pair of pressing rollers may be provided.

When the forming mold 2 travels on the traveling passage 13a of the conveying device 13, the upper roller 5a descends under the function of the air cylinder so that the front portions of the forming mold 2 and the substrate 4 are held between the upper roller 5a and the lower roller 5b. Both the upper and lower rollers 5a, 5b roll to move the forming mold 2 in one direction. Accordingly, the ionizing radiation curing type resin 3 is spread through the substrate 4 so as to be flattened.

The ionizing radiation irradiating device 12, which is composed of a ultraviolet lamp or the like, is disposed on the downstream side of the pressing rollers 5a, 5b on the traveling passage 13a of the conveying device 13. Ionizing radiation 7, which is irradiated on the ionizing radiation curing type resin 3 through the substrate 4 from the ionizing radiation irradiating device 12, cures the ionizing radiation curing type resin 3. When the forming mold 2 is carried on the filter 14b and stands in a non-moving state, the ionizing radiation curing type resin 3, which has been cured by irradiation of the ionizing radiation 7, is peeled from the forming mold 2 by a manual operation.

Now, description will be given below of a series of operations of the above-described apparatus for manufacturing lens sheets.

Driving the conveying device 13 circulates the forming molds 2 in the apparatus for manufacturing lens sheets.

The temperature-adjusting device 10 carries out temperature adjustment of the forming mold 2, which is out of an actual formation of the lens sheet and temporarily stops traveling before the returning lifter 14a.

The first nozzle 8 applies the ionizing radiation curing type resin in the form of liquid on the entirety of the upper surface of the forming mold 2, which has been subjected to the temperature adjustment, to form the first uncured resin layer on the inlet portion of the traveling passage 13a of the conveying device 13.

The ionizing radiation curing type resin 3, which circulates in the piping, is poured from the first valve 9, when the forming mold 2 moves below the first nozzle 8 and the discharge valve 22 is opened. The forming mold 2 travels at a constant speed below the first nozzle 8 so that the ionizing radiation curing type resin 3 is applied on the forming mold 2 in a constant thickness.

The second nozzle 9 applies the ionizing radiation curing type resin 3 in the form of liquid on one side, i.e., the pressing-starting side of the first uncured layer formed on the forming mold 2, on the downstream side of the first nozzle 8 to form an uncured resin pool on the first uncured layer. Application of the ionizing radiation curing type resin 3 through the second nozzle 9 is carried out after the operation of the traveling passage 13a of the conveying device 13 is temporarily stopped to keep the forming mold 2 in a non-moving state.

The forming mold 2 on which the first uncured layer and the uncured resin pool have been formed, is carried to a position of the substrate supply device 11 by the traveling passage 13a of the conveying device 13. The forming mold 2 temporarily stops traveling immediately after it reaches to the above-mentioned position. The forming mold 2 may continuously travel. The substrate-supply device 11 carries the substrate 4 above the forming mold 2 in an inclined state that the front end of the substrate is lower than the rear end thereof in the traveling direction of the forming mold 2, and brings the front end of the substrate 4 into contact with the front end of the forming mold 2.

The traveling passage 13a of the endless conveying device 13 carries the forming mold 2 on which the front end of the substrate 4 has been placed, toward the pressing rollers 5a, 5b. The substrate-supply device 11 supplies the substrate 4 toward the pressing rollers 5a, 5b in synchronization with the traveling motion of the traveling passage 13a. When the forming mold 2 travels on the traveling passage 13a of the conveying device 13 to a prescribed position, the upper roller 5a descends so that the forming mold 2 and the substrate 4 are held, at their pressing-starting side, between the upper and lower rollers 5a, 5b. Both the upper and lower rollers 5a, 5b roll to move the forming mold 2 in one direction. Accordingly, the uncured resin pool is spread on the first uncured layer through the substrate 4 to be flattened through the substrate 4, thus forming the second uncured layer on the first resin layer. The first and second uncured layers are actually combined into a single united layer having a uniform thickness.

The traveling passage 13a of the conveying device 13 carries the forming mold 2, which has passed between the pressing rollers 5a, 5b, to the ionizing radiation irradiating device 12. The forming mold 2 passes below the ionizing radiation irradiating device 12. The forming mold 3 may temporarily stop traveling below the ionizing radiation irradiating device 12. The ionizing radiation irradiating device 12 irradiates ionizing radiation 7 on the first and second layers of the ionizing radiation curing type resin 3 through the substrate 4 to cure them.

The traveling passage 13a of the conveying device 13 carries the forming mold 2 on the lifter 14b. When the forming mold 2 is carried on the filter 14b and stands in a non-moving state, the ionizing radiation curing type resin 3, which has been cured by irradiation of the ionizing radiation 7, i.e., a lens sheet as a semi-finished product is peeled from the forming mold 2 by a manual operation.

Then, the forming mold 2 from which the semi-finished product has been removed, is returned to a position of the temperature-adjusting device 10 by the operation of the returning passage 13b. The forming mold 2 is then subjected to the temperature adjustment through the temperature-adjusting device 10 and then returned again to the traveling passage 13a so that it can be used for the next formation of the lens sheet.

<Second Embodiment>

The lens sheet manufacturing apparatus of the second embodiment of the present invention has the similar structure to that of the first embodiment of the present invention. According to the second embodiment of the present invention, it is however possible to manufacture two kinds of lens sheets, which have different dimensions in design or are made of different material from each other, while traveling two kinds of forming molds having the different dimensions from each other on the same endless conveying device.

The lens sheet manufacturing apparatus has the fundamental structure, which is similar to that as shown in FIG. 6. However, formation conditions differ depending upon the kind of the forming mold 2. The formation conditions are therefore automatically changed in accordance with the kind of the forming mold 2.

The formation conditions depending on the dimensions of forming mold are as follows:

(1) for the first nozzle 8 in the first embodiment, for applying the ionizing radiation curing type resin 3 on the entirety of the upper surface of the forming mold 2, an application width of the ionizing radiation curing type resin 3, an amount of resin poured, a pouring-starting position, a pouring-finishing position and a temperature adjustment of the nozzle;

(2) for the substrate supply device 11, the size of the substrate; and

(3) pressing force of the pressing rollers Sa, 5b, a pressing-starting position and a pressing-finishing position, and a temperature adjustment of the nozzle.

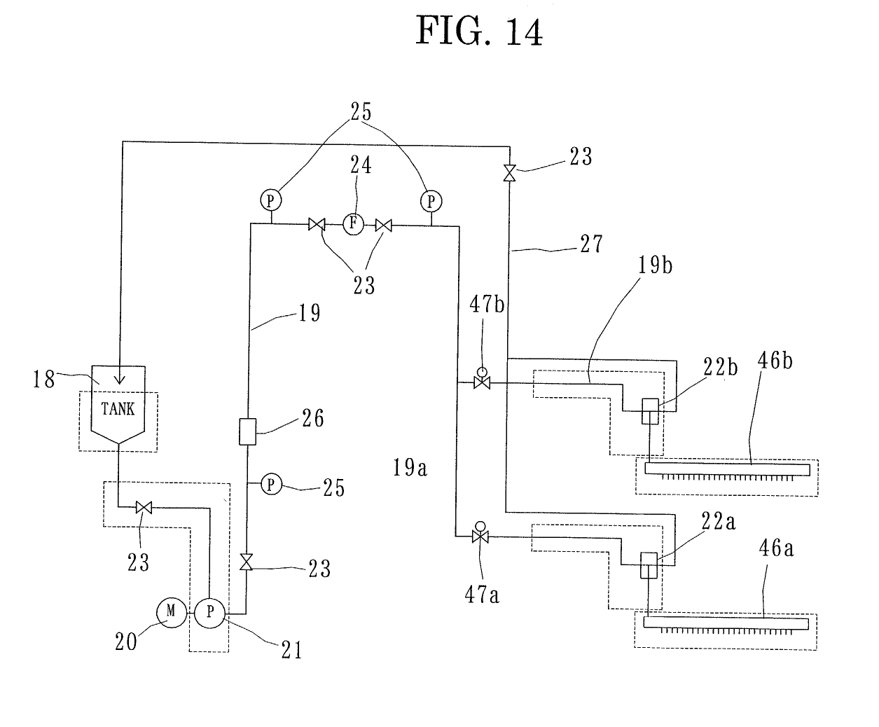

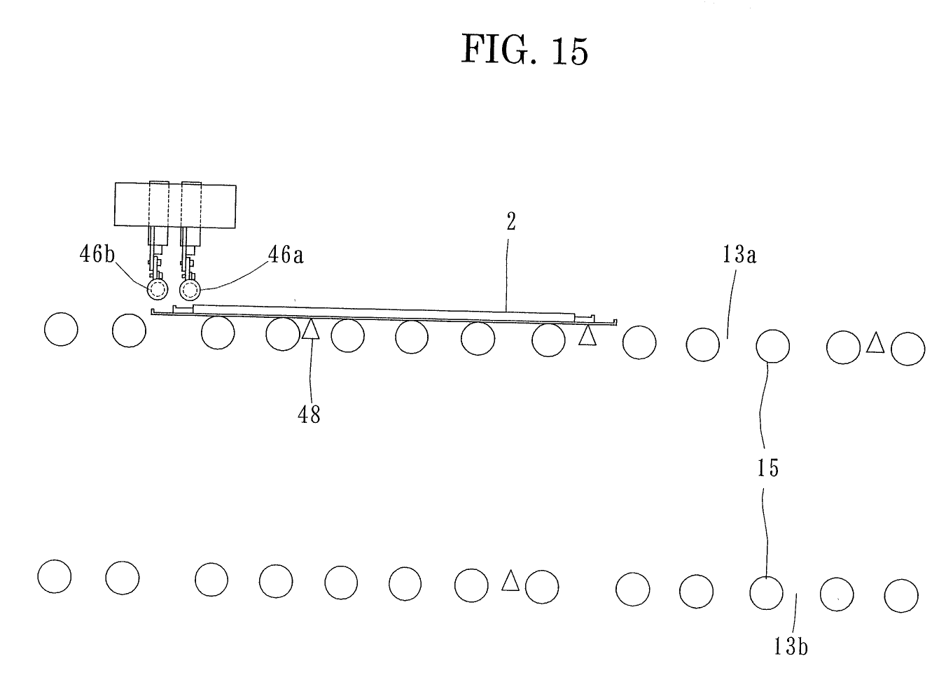

The application width listed in the item (1) above can be adjusted by arranging two kinds of first nozzle 46a, 46b on the traveling passage 13a of the conveying device 13 and providing the supply conduits 19a, 19b for supplying the ionizing radiation curing type resin 3 into the respective nozzles 46a, 46b with automatic valves 47a, 47b, respectively, as shown in FIGS. 14 and 15. The multiple nozzles 46a, 46b correspond to the respective forming molds 2 and portions of the nozzle pipes 8b, which are not to be used taking into consideration the width of the forming mold 2, are closed by means of the adjusting device 17, as shown in FIGS. 7 and 8.

The amount of resin poured listed in the item (1) above can be adjusted by changing number of revolutions of the pump 21.

The pouring-starting position, the pouring-finishing position and the pouring position listed in the item (1) above can be adjusted by carrying out a switching operation of a timer (not shown).

Change in size of the substrate 4 listed in the item (2) above can be made by carrying out a switching operation for changing a range of operation of the robot 43 and a switching operation for the suction cups 34 for sucking the substrate 4.

The pressing force listed in the item (3) above can be adjusted by carrying out a switching operation of a pressure regulator (not shown).

Identification of two kinds of forming mold 2 can be performed by a preset method or a sensing method. With respect to the sensing method, a metallic piece (not shown) is for example attached on the end surface of the base plate 2c of the forming mold 2. Detecting existence of the metallic piece on the upstream side of the conveying device 13 with the use of a proximity sensor 48 performs identification of two kinds of forming mold 2.

Detecting the existence of the metallic piece by means of the proximity sensor 48 causes one of the automatic valve 47a and 47b for the corresponding forming mold to be opened and the other thereof to be closed so that the ionizing radiation curing type resin 3 is applied in an appropriate width through the corresponding multiple nozzle 46a or 46b. The number of revolutions of the pump 21 is adjusted to an appropriate one so as to change the amount of resin poured in a proper manner. In addition, the switching operation of the timer (not shown) is carried out so as to change the pouring-starting position and the pouring-finishing position in an appropriate manner. The size of the substrate 4 varies depending upon the kind of the forming mold 2. Accordingly, a switching operation is carried out to change a range of operation of the robot 43 in the substrate supply device 11 and a switching operation for the sets of suction cups 34, 35, 36 for sucking the substrate 4 is also carried out in accordance with the size of the substrate to be used. The switching operation of the pressure regulator (not shown) is also carried out so as to change the pressing force given by the pressing rollers 5a, 5b. The switching operation of the timer (not shown) is also carried out so as to change the pressing-starting position and the pressing-finishing position of the pressing rollers 5a, 5b.

It is therefore possible to manufacture two kinds of lens sheet 1, which have different dimensions from each other, with the use of the same apparatus for manufacturing a lens sheet.

In the above-described embodiment, two kinds of forming mold are used. The present invention may be applied to a case where three or more kinds of forming mold are used.

In the first aspect of the present invention as described in detail, the method for manufacturing a lens sheet, comprises: a resin-application step for applying ionizing radiation curing type resin in a form of liquid on an entirety of an upper surface of a forming mold to form an uncured resin layer on the upper surface of said forming mold; a laminating step for putting a substrate in an inclined state relative to the upper surface of said forming mold, then placing the substrate on said uncured resin layer and then pressing said substrate against said uncured resin layer by means of a pressing roller; a curing step for irradiating ionizing radiation on said uncured resin layer through said substrate to cure said uncured resin layer, thereby forming a cured resin layer; and a removing step for removing said cured resin layer together with said substrate from said forming mold. According to the above-mentioned features of the first aspect of the present invention, the substrate is put in the inclined state relative to the upper surface of the forming mold, placed on the uncured resin layer and then pressed against the uncured resin layer by means of the pressing roller. It is therefore possible to flatten the resin so as not to entrap bubbles therein, without applying the ionizing radiation curing type resin in an increased thickness or forming an uncured resin pool on a part of the upper surface of the forming mold on a pressing-starting side. An amount of ionizing radiation curing type resin as used can be reduced. The substrate is placed on the uncured resin layer in the inclined state, without curving or bending the substrate, thus making it possible to prevent the substrate from being deformed and/or deteriorated.

In the second aspect of the present invention, the pressing of said laminating step may comprise continuously pressing said substrate from said one side of the forming mold to an other side thereof, said one side of the forming mold serving as a pressing-starting side; and there may be carried out, after said resin-application step and before said laminating step, a partial-surface application step for applying the ionizing radiation curing type resin on a part of said uncured resin layer on said pressing-starting side to form a uncured resin pool thereon. According to such a feature, if an amount of ionizing radiation curing type resin as first applied is insufficient, it is possible to supplement such an insufficient amount of resin. In addition, in cooperation with the feature that the substrate is put in the inclined state relative to the upper surface of the forming mold, placed on the uncured resin layer and then pressed against the uncured resin layer by means of the pressing roller, entrapment of bubbles can be prevented even when an amount of resin for the uncured resin pool is relatively small.

In the third aspect of the present invention, the method may further comprise a mold-temperature adjusting step for adjusting temperature of the forming mold to a prescribed temperature, which is suitable to formation of a lens sheet, said mold-temperature adjusting step being followed by said resin-application step. According to such a feature, the temperature of the forming mold is adjusted to the prescribed temperature, which is suitable to formation of the lens sheet. It is therefore possible to ensure a smooth flow of the ionizing radiation curing type resin as applied by the resin-application step when flattening it through the substrate by means of the pressing roller so as to prevent properly bubbles from being entrapped between the substrate and the forming mold.

In the fourth aspect of the present invention, said resin-application step, said laminating step, said curing step and said removing step may be carried out on a traveling passage of an endless conveying device for conveying the forming mold, and said mold-temperature adjusting step may be carried out on a returning passage of said endless conveying device. According to such a feature, it is possible to manufacture a lens sheet, while circulating the forming molds on the endless conveying device. In addition, the temperature of the forming mold can be adjusted before it is returned to the starting position of the traveling passage. Consequently, manufacture of a lens sheet can be conducted without specifically providing any period of time for carrying out a mold-temperature adjusting step.

In the fifth aspect of the present invention, the apparatus for manufacturing a lens sheet comprises: a nozzle for applying ionizing radiation curing type resin in a form of liquid on an upper surface of a forming mold to form an uncured resin layer on the upper surface of said forming mold; a substrate supply device for putting a substrate in an inclined state relative to the upper surface of said forming mold and placing the substrate on said uncured resin layer; a pressing roller for pressing said substrate against said uncured resin layer; and an irradiation device for irradiating ionizing radiation on said uncured resin layer through said substrate to cure said uncured resin layer. According to the above-mentioned features of the fifth aspect of the present invention, the ionizing radiation curing type resin as applied by the nozzle is flattened through the substrate by means of the pressing roller so as to prevent properly bubbles from being entrapped between the substrate and the forming mold. In addition, in cooperation with the feature that the substrate is put in the inclined state relative to the upper surface of the forming mold, placed on the uncured resin layer and then pressed against the uncured resin layer by means of the pressing roller, it is possible to flatten the uncured resin layer so as not to entrap bubbles, without applying the ionizing radiation curing type resin on a pressing-starting side of the forming mold. An amount of ionizing radiation curing type resin as used can be reduced. The substrate is placed on the uncured resin layer in the inclined state, without curving or bending the substrate, thus making it possible to prevent the substrate from being deformed and/or deteriorated.

In the sixth aspect of the present invention, the apparatus may further comprise an additional nozzle for applying the ionizing radiation curing type resin on a part of said uncured resin layer to form a uncured resin pool thereon. According to such a feature, if an amount of ionizing radiation curing type resin as first applied is insufficient, it is possible to supplement such an insufficient amount of resin by means of the nozzle for applying the resin to form the uncured resin pool. In addition, in cooperation with the feature that the substrate is put in the inclined state relative to the upper surface of the forming mold, placed on the uncured resin layer and then pressed against the uncured resin layer by means of the pressing roller, it is possible to flatten the ionizing radiation curing type resin, without causing entrapment of bubbles, even when an amount of resin for the uncured resin pool is relatively small.

In the seventh aspect of the present invention, the apparatus may further comprise a mold-temperature adjusting device for adjusting temperature of the forming mold to a prescribed temperature, which is suitable to formation of a lens sheet. According to such a feature, the temperature of the forming mold is adjusted to the prescribed temperature, which is suitable to formation of the lens sheet. It is therefore possible to ensure a smooth flow of the ionizing radiation curing type resin as applied on the forming mold when flattening it through the substrate by means of the pressing roller so as to prevent properly bubbles from being entrapped between the substrate and the forming mold.

In the eighth aspect of the present invention, said nozzle, said substrate supply device, said pressing roller and said irradiation device may be provided on a traveling passage of an endless conveying device for conveying the forming mold, and said mold-temperature adjusting device may be provided on a returning passage of said endless conveying device. According to such a feature, it is possible to manufacture a lens sheet, while circulating the forming molds on the endless conveying device. In addition, the mold-temperature adjusting device is disposed on the returning passage of the endless conveying device so that the temperature of the forming mold can be adjusted before it is returned to the starting position of the traveling passage. Consequently, temperature adjustment of the forming mold can be carried out utilizing a non-service period of time for the forming mold. It is also possible to prevent the length of the conveying device from increasing.

In the ninth aspect of the present invention, said substrate supply device may supply the substrate in synchronization with traveling of the forming mold, which is caused by driving of the traveling passage of said endless conveying device. According to such a feature, it is possible to place the substrate on the ionizing radiation curing type resin, while traveling the forming mold, thus improving efficiency in manufacture of a lens sheet.

The entire disclosure of Japanese Patent Application No. 2000-361188 filed on Nov. 28, 2000 including the specification, claims, drawings and summary is incorporated herein by reference in its entirety.

What is claimed is:

1. A method for manufacturing a lens sheet, comprising:
a resin-application step for applying ionizing radiation curing type resin in a form of liquid on an entirety of an upper surface of a forming mold to form an uncured resin layer on the upper surface of said forming mold;
a laminating step for putting a substrate in an inclined state relative to the upper surface of said forming mold, then placing the substrate on said uncured resin layer and then pressing said substrate against said uncured resin layer by means of a pressing roller;
a curing step for irradiating ionizing radiation on said uncured resin layer through said substrate to cure said uncured resin layer, thereby forming a cured resin layer; and
a removing step for removing said cured resin layer together with said substrate from said forming mold.

2. The method as claimed in claim 1, wherein:
the pressing of said laminating step comprises continuously pressing said substrate from said one side of the forming mold to an other side thereof, said one side of the forming mold serving as a pressing-starting side; and
there is carried out, after said resin-application step and before said laminating step, a partial-surface application step for applying the ionizing radiation curing type resin on a part of said uncured resin layer on said pressing-starting side to form a uncured resin pool thereon.

3. The method as claimed in claim 1, further comprising:
a mold-temperature adjusting step for adjusting temperature of the forming mold to a prescribed temperature, which is suitable to formation of a lens sheet, said mold-temperature adjusting step being followed by said resin-application step.

4. The method as claimed in claim 2, further comprising:
a mold-temperature adjusting step for adjusting temperature of the forming mold to a prescribed temperature, which is suitable to formation of a lens sheet, said mold-temperature adjusting step being followed by said resin-application step.

5. The method as claimed in claim 3, wherein:
said resin-application step, said laminating step, said curing step and said removing step are carried out on a traveling passage of an endless conveying device for conveying the forming mold, and said mold-temperature adjusting step is carried out on a returning passage of said endless conveying device.

6. The method as claimed in claim 4, wherein:
said resin-application step, said laminating step, said curing step and said removing step are carried out on a traveling passage of an endless conveying device for conveying the forming mold, and said mold-temperature adjusting step is carried out on a returning passage of said endless conveying device.

7. An apparatus for manufacturing a lens sheet comprising:
a nozzle for applying ionizing radiation curing type resin in a form of liquid on an upper surface of a forming mold to form an uncured resin layer on the upper surface of said forming mold;
a substrate supply device for putting a substrate in an inclined state relative to the upper surface of said forming mold and placing the substrate on said uncured resin layer;
a pressing roller for pressing said substrate against said uncured resin layer; and
an irradiation device for irradiating ionizing radiation on said uncured resin layer through said substrate to cure said uncured resin layer.

8. The apparatus as claimed in claim 7, further comprising:
an additional nozzle for applying the ionizing radiation curing type resin on a part of said uncured resin layer to form a uncured resin pool thereon.

9. The apparatus as claimed in claim 7, further comprising:
a mold-temperature adjusting device for adjusting temperature of the forming mold to a prescribed temperature, which is suitable to formation of a lens sheet.

10. The apparatus as claimed in claim 8, further comprising:
a mold-temperature adjusting device for adjusting temperature of the forming mold to a prescribed temperature, which is suitable to formation of a lens sheet.

11. The apparatus as claimed in claim 7, wherein:
said nozzle, said substrate supply device, said pressing roller and said irradiation device are provided on a traveling passage of an endless conveying device for conveying the forming mold, and said mold-temperature adjusting device is provided on a returning passage of said endless conveying device.

12. The apparatus as claimed in claim 8, wherein:
said nozzle, said substrate supply device, said pressing roller and said irradiation device are provided on a traveling passage of an endless conveying device for conveying the forming mold, and said mold-temperature adjusting device is provided on a returning passage of said endless conveying device.

13. The apparatus as claimed in claim 9, wherein:
said nozzle, said substrate supply device, said pressing roller and said irradiation device are provided on a traveling passage of an endless conveying device for conveying the forming mold, and said mold-temperature adjusting device is provided on a returning passage of said endless conveying device.

14. The apparatus as claimed in claim 10, wherein:
said nozzle, said substrate supply device, said pressing roller and said irradiation device are provided on a traveling passage of an endless conveying device for conveying the forming mold, and said mold-temperature adjusting device is provided on a returning passage of said endless conveying device.

15. The apparatus as claimed in claim 7, wherein:
said substrate supply device supplies the substrate in synchronization with traveling of the forming mold, which is caused by driving of the traveling passage of said endless conveying device.

16. The apparatus as claimed in claim 8, wherein:
said substrate supply device supplies the substrate in synchronization with traveling of the forming mold, which is caused by driving of the traveling passage of said endless conveying device.

17. The apparatus as claimed in claim 9, wherein:
said substrate supply device supplies the substrate in synchronization with traveling of the forming mold, which is caused by driving of the traveling passage of said endless conveying device.

18. The apparatus as claimed in claim 10, wherein:
said substrate supply device supplies the substrate in synchronization with traveling of the forming mold, which is caused by driving of the traveling passage of said endless conveying device.

19. The apparatus as claimed in claim 11, wherein:
said substrate supply device supplies the substrate in synchronization with traveling of the forming mold, which is caused by driving of the traveling passage of said endless conveying device.

20. The apparatus as claimed in claim 12, wherein:
said substrate supply device supplies the substrate in synchronization with traveling of the forming mold, which is caused by driving of the traveling passage of said endless conveying device.

21. The apparatus as claimed in claim 13, wherein:
said substrate supply device supplies the substrate in synchronization with traveling of the forming mold, which is caused by driving of the traveling passage of said endless conveying device.

22. The apparatus as claimed in claim 14, wherein:
said substrate supply device supplies the substrate in synchronization with traveling of the forming mold, which is caused by driving of the traveling passage of said endless conveying device.
